(19) United States
(12) Patent Application Publication
(10) Pub. No.: US 2015/0204965 A1
(43) Pub. Date: Jul. 23, 2015

(54) POSITION SPECIFICATION SYSTEM AND METHOD

(71) Applicants: Naofumi Magarida, Sunto-gun (JP); Atsushi Mizutani, Mishima-shi (JP); Yuta Oshiro, Mishima-shi (JP)

(72) Inventors: Naofumi Magarida, Sunto-gun (JP); Atsushi Mizutani, Mishima-shi (JP); Yuta Oshiro, Mishima-shi (JP)

(73) Assignee: TOYOTA JIDOSHA KABUSHIKI KAISHA, Toyota-shi, Aichi (JP)

(21) Appl. No.: 14/411,995

(22) PCT Filed: Jul. 6, 2012
(86) PCT No.: PCT/JP2012/067352

§ 371 Date: Dec. 30, 2014

(51) Int. Cl. G01S 5/30

(52) U.S. Cl. CPC G01S 5/30

(57) ABSTRACT

As regards a mobile terminal brought into a vehicle interior of a vehicle, a position of the mobile terminal in the vehicle interior is specified. In a position specification system that includes a mobile terminal and an information association apparatus configured to enable wireless communication with each other, the system being configured so that the information association apparatus specifies a position of the mobile terminal in a vehicle interior when the mobile terminal brought into the vehicle interior of a vehicle detects signal sounds produced from speakers provided in the vehicle, the mobile terminal includes: means configured to store detection information concerning times at which the signal sounds were detected; and means configured to transmit a first notification signal including the detection information, and the information association apparatus includes: means configured to enable each of the plurality of speakers to transmit the signal sound at intervals of a predetermined time width; and means configured to specify a position of the mobile terminal in the vehicle interior with the use of relative distances of a plurality of sound sources of the signal sounds and the mobile terminal calculated based on intervals of times at which the signal sounds were detected and the predetermined time width and with the use of information concerning the speakers.

### TECHNICAL FIELD

The present invention relates to a position specification system and method that specify a position of a mobile terminal, which has been brought into a vehicle interior of a vehicle, in the vehicle interior.

### BACKGROUND ART

Various technologies that determine presence/absence of a mobile terminal brought into a vehicle interior of a vehicle have been known. Further, a technology configured to specify a mobile terminal owned by a driver of a vehicle has been developed, and a technology that specifies a position of a mobile terminal in a vehicle interior or specifies a seat on which a passenger who owns this mobile terminal is sitting has been widely known. Many of such technologies are configured so that an on-vehicle device configured to enable bidirectional communication with a mobile terminal in a vehicle interior through an antenna provided in a vehicle determines presence/absence of the mobile terminal in the vehicle interior based on data transmitted to or received from the mobile terminal and specifies a position of the mobile terminal or a seat on which a passenger who owns this mobile terminal is sitting.

For example, Japanese Unexamined Patent Application Publication No. 2009-140445 discloses a vehicle monitoring apparatus configured to perform wireless communication with a mobile phone brought into a vehicle interior through a short range communication antenna provided in the vehicle interior. This vehicle monitoring apparatus is configured to detect a mobile phone present in a range that electric waves radiated from the antenna reach and specify a seat corresponding to a communication area of the antenna that has received a terminal ID transmitted from the mobile phone. Further, the vehicle monitoring apparatus is configured to transmit various kinds of commands to the mobile phone and control an operation of the mobile phone in accordance with a type of a received command.

Furthermore, Japanese Unexamined Patent Application Publication No. 2011-228828 discloses an apparatus that determines presence/absence of a mobile terminal in a communication area of an antenna in response to receiving a wireless signal from a mobile terminal device in a vehicle interior through the antenna arranged near a seat in the vehicle interior and specifies a seat corresponding to this area. Moreover, this apparatus is configured to control a sound volume of a speaker closest to this specified seat to OFF.

However, in the apparatuses disclosed in the respective references, the communication area of the antenna is restricted to a range including a seat that should be assigned to each antenna and configured not to overlap the communication antenna of any other antenna. Therefore, when the antenna fails to operate properly, since another antenna cannot cover a communication area of the failed antenna, a mobile terminal in this area cannot be detected even though the mobile terminal has been brought into the vehicle interior. Therefore, there is a possibility that all mobile terminals that have been brought into the vehicle interior cannot be accurately detected. Further, the antennal must be provided in accordance with each seat, and a plurality of antennas must be freshly installed in a vehicle that is not originally equipped with such antennas. Therefore, installing dedicated antennas raises a manufacturing cost or an introduction cost.

### DISCLOSURE OF THE INVENTION

In view of the above-described technical problem, it is an object of the present invention to provide a position specification system and method that specify a position of a mobile terminal, which has been brought into a vehicle interior, in the vehicle interior.

To achieve this object, according to the present invention, there is provided a position specification system including a mobile terminal and an information association apparatus configured to enable wireless communication with each other, the system being configured so that the information association apparatus specifies a position of the mobile terminal in a vehicle interior when the mobile terminal brought into the vehicle interior of a vehicle detects signal sounds produced from speakers provided in the vehicle, wherein the mobile terminal includes: detection information memory means configured to store detection information concerning a time at which the signal sound produced from each of the plurality of speakers was detected; and first notifying means configured to transmit a first notification signal including the detection information, and the information association apparatus includes: sound source control unit means configured to control so that the signal sound is produced in accordance with each of the plurality of speakers at intervals of a predetermined time width; and position specifying means configured to specify a position of the mobile terminal in the vehicle interior with the use of relative distances of a plurality of sound sources of the signal sounds and the mobile terminal calculated based on intervals of times at which the signal sounds were detected and the predetermined time width and with the use of information concerning the speakers in a case where the first notification signal has been received.

In the above-described invention, the present invention provides the position specification system characterized in that the mobile terminal further includes calculating means configured to calculate intervals of times at which the plurality of signal sounds were detected, respectively, compare the intervals with each other, and calculate relative distances of the sound sources of the signal sounds and the mobile terminal, the detection information includes information concerning the intervals of the times, the first notifying means transmits the first notification signal including information of the relative distances, and the position specifying means is configured to specify a position of the mobile terminal with the use of the information of the relative distances included in the first notification signal.

In the above-described invention, the present invention provides the position specification system characterized in that the information concerning the speakers includes at least one of arrangement information of the speakers provided in the vehicle interior and order information of the speakers that have emitted the signal sounds, the sound source control unit means controls the plurality of speakers to emit the signal sounds at equal intervals of a time width, the calculating means calculates a ratio of the distances between the plurality of sound sources and the mobile terminal with the use of the intervals of the detection times and the time width of the equal intervals, the first notification signal including the ratio of the distances is transmitted as the first notification signal, and the position specifying means is configured to specify a position of the mobile terminal relative to the plurality of speakers with the use of the ratio of the distances included in the first notification signal.

In the above-described invention, the present invention provides the position specification system characterized in that the information association apparatus further includes second notifying means configured to transmit a second notification signal including pattern information indicating that two or more speakers, which emit the signal sounds, have been selected from the plurality of speakers, the calculating means calculates the relative distances by using the pattern information included in the second notification signal and the intervals of the signal sound detection times when the second notification signal has been received, the sound source control unit means controls the speakers to emit the signal sounds based on the pattern information, and the position specifying means is configured to specify a position of the mobile terminal in the vehicle interior by using the relative distances and the pattern information.

In the above-described invention, the present invention provides the position specification system characterized in that the first notification signal includes information of the intervals between the times at which the signal sounds were detected, the information association apparatus further includes calculating means configured to compare the intervals between the plurality of times included in the first notification signal with each other and calculate relative distances of the mobile terminal and the speakers by using the intervals when the first notification signal has been received, and the position specifying means is configured to specify a position of the mobile terminal by using information of the relative distances of the speakers and the mobile terminal.

In the above-described invention, the present invention provides the position specification system characterized in that the information concerning the speakers includes at least one of arrangement information of the speakers provided in the vehicle interior and order information of the speakers that have emitted the signal sounds, the sound source control unit means allows the plurality of speakers to emit the signal sounds at equal intervals of a time width, the calculating means calculates a ratio of the distances between the plurality of sound sources and the mobile terminal with the use of the intervals of the detection times and the time width of the equal intervals, and the position specifying means is configured to specify a position of the mobile terminal in the vehicle interior by using the calculated ratio of the distances.

In the above-described invention, the present invention provides the position specification system characterized in that the information association apparatus further includes second notifying means configured to transmit a second notification signal including pattern information indicating that two or more speakers, which emit the signal sounds, have been selected from the plurality of speakers, the mobile terminal further includes determining means configured to determine whether the number of the selected speakers included in the pattern information coincides with the number of times of detecting the signal sounds when the second notification signal has been received, the sound source control unit means controls the speakers to emit the signal sounds based on the pattern information, the calculating means calculates the relative distances by using the intervals of the times at which the signal sounds were detected and the pattern information, and the position specifying means is configured to specify a position of the mobile terminal in the vehicle interior by using the calculated relative distances.

In the above-described invention, the present invention provides the position specification system characterized in that the information association apparatus further includes determining means configured to determine which one of a plurality of determination areas the positional information of the mobile terminal in the vehicle interior corresponds to by using the determination areas provided by dividing the vehicle interior in a predetermined range.

In the above-described invention, the present invention provides the position specification system characterized in that information of seats in the vehicle interior is associated with the determination areas, and the information association apparatus further includes driver terminal specifying means configured to specify the mobile terminal as a driver's mobile terminal when positional information of the mobile terminal corresponds to the determination area associated with information of a driver's seat.

According to the present invention, there is provided a position specification method for specifying a position of a mobile terminal in a vehicle interior by an information association apparatus when the mobile terminal and the information association apparatus are configured to enable mutual wireless communication and the mobile terminal brought into the vehicle interior of a vehicle detects signal sounds produced from speakers provided in the vehicle, the method including; a step of producing the signal sound in accordance with each of the plurality of speakers at equal intervals of a time width; a step of storing detection information concerning times at which the mobile terminal detected the signal sounds produced from the plurality of speakers, respectively; a step of transmitting a first notification signal including the detection information concerning the times at which the signal sounds were detected from the mobile terminal; and a step of specifying a position of the mobile terminal in the vehicle interior with the use of relative distances of the plurality of sound sources of the signal sounds and the mobile terminal calculated based on the intervals of the times at which the signal sounds were detected and the predetermined time width and with the use of information concerning the speakers when the information association apparatus has subsequently received the first notification signal.

In the above-described invention, the present invention provides the position specification method characterized by further including a step of calculating intervals of times at which the plurality of signal sounds were detected, respectively, comparing the intervals with each other, and calculating relative distances of the sound sources of the signal sounds and the mobile terminal by using the time width of the equal intervals.

In the above-described invention, the present invention provides the position specification method characterized by further including a step of specifying the mobile terminal as a driver's mobile terminal when positional information of the mobile terminal corresponds to the determination area associated with information of a driver's seat.

According to the present invention, using the signal sounds generated from the speakers provided in the vehicle interior enables specifying a position of the mobile terminal brought into the vehicle interior. That is, the position of the mobile terminal in the vehicle interior can be specified by using the speakers. Further, since the signal sounds generated from the speakers are not propagated in a restricted area alone, the mobile terminal present in the vehicle interior can detect the signal sounds generated from the plurality of speakers. That is, using relative distances of the mobile terminal and the sound sources of the signal sounds calculated based on intervals of times at which the signal sounds were detected enables specifying the position of the mobile terminal in the vehicle interior.

According to the present invention, the intervals of the times at which the mobile terminal detected the plurality of signal sounds can be calculated, and the relative positions of the sound sources of the signal sounds and the mobile terminal can be calculated with the use of the intervals. Thus, the relative position can be calculated in the mobile terminal without notifying the mobile terminal of information, e.g., information of a time at which each speaker generated the signal sound by the information association apparatus at the time of generating the signal sound.

According to the present invention, the signal sounds are generated from the plurality of speakers at different timings, and the signal sounds are generated at equal intervals. Therefore, in the mobile terminal, the relative positions of the sound sources of the detected signal sounds and the mobile terminal can be calculated even though the information of the times at which the signal sounds were generated from the speakers are not known. Moreover, the relative positions can be calculated based on a ratio of the distances of the plurality of sound sources and the mobile terminal.

According to the present invention, it is possible to select the speaker that generates the signal sound from the plurality of speakers provided in the vehicle. Therefore, it is possible to select the speakers so that the number of sound sources required to specify the position of the mobile terminal in the vehicle interior can be achieved. Additionally, since the mobile terminal has been notified of the pattern information from the information association apparatus, the mobile terminal can be used to determine whether the number of the speakers that have generated the signals sounds actually coincides with the number of the signal sounds detected by the mobile terminal. Therefore, the mobile terminal can determine that the speaker that has generated the undetected signal sound is present.

According to the present invention, in the information association apparatus, the relative position of the mobile terminal that has detected signal sound and the sound source that has generated this signal sound can be calculated. In this case, intervals of times at which the signal sounds were detected can be calculated in accordance with each first notification signal, i.e., each mobile terminal, and the relative position with respect to each speaker can be calculated in accordance with each mobile terminal by comparing the intervals. Further, since the speaker as the sound source can be specified, the position of the mobile terminal in the vehicle interior can be specified based on arrangement of the speakers in the vehicle interior.

According to the present invention, since the signal sounds are emitted from the respective speakers at equal intervals, in the information association apparatus, a ratio of distances of the mobile terminal and the plurality of speakers as the sound sources of the signal sounds can be calculated by using intervals of times at which the mobile terminal detected the signal sounds.

According to the present invention, the speaker that emits the signal sound can be selected from the speakers provided in the vehicle. In the information association apparatus, the relative position of the mobile terminal and each speaker can be calculated by using the pattern information. Furthermore, the position of the mobile terminal in the vehicle interior can be specified from the arrangement of each speaker selected as the sound source and the relative distance of the same.

According to the present invention, it is possible to determine whether the position of the mobile terminal in the vehicle interior corresponds to its position determination area. Therefore, presence/absence of a mobile phone placed on a seat corresponding to the determination area can be detected, and this mobile terminal can be specified. Moreover, it is not necessary to control a range in which the signal sound emitted from each speaker is propagated to be restricted to this determination area.

According to the present invention, the mobile terminal placed in the position determination area associated with the driver's seat can be detected, and this mobile terminal can be specified as the driver's mobile terminal.

According to the present invention, after the mobile terminal brought into the vehicle interior is detected, a position of the mobile terminal in the vehicle interior can be specified, Further, a relative position relationship between each sound source of the detected signal sound and the mobile terminal can be estimated, and the estimated relative position can be specified as a position in the vehicle interior.

According to the present invention, using the signal sounds emitted from the speakers provided in the vehicle enables detecting the mobile terminal brought into the vehicle interior and specifying a position of the mobile terminal in the vehicle interior, and hence this position specification system can be introduced as a configuration having general versatility. Therefore, dedicated constituent members do not have to be provided in the vehicle, and the introduction cost can be suppressed, Furthermore, calculating a relative position of each sound source of the signal sound and the mobile terminal with the use of either the mobile terminal or the information association apparatus can suffice, and the general versatility can be further enhanced.

### BRIEF DESCRIPTION OF DRAWINGS

FIG. 1 is a view schematically showing, in the form of function blocks, an information association apparatus and a mobile terminal constituting a position specification system according to an embodiment of the present invention;

FIG. 2 is a flowchart showing an example of information processing executed by the mobile terminal and the information association apparatus brought into a vehicle interior;

FIG. 3 is a view schematically showing the vehicle interior of a vehicle to which the position specification system according to this embodiment can be applied;

FIG. 4 is a view showing a positional relationship between the mobile terminal brought into the vehicle interior and speakers provided in the vehicle interior;

FIG. 5 is a view schematically showing, in the form of function blocks, an information association apparatus and a mobile terminal constituting a position specification system in another specific example according to the present invention;

FIG. 6 is a flowchart showing an information processing example executed the mobile terminal and the information association apparatus in the position specification system in another specific example;

FIG. 7 is a view schematically showing an example of a configuration in the vehicle interior;

FIG. 8 is a view schematically showing another example of the configuration in the vehicle interior;

FIG. 9 is a view schematically showing still another example of the configuration in the vehicle interior;

FIG. 10 is a view schematically showing, in the form of function blocks, an information association apparatus and a mobile terminal constituting a position specification system in another embodiment according to the present invention;

FIG. 11 is a flowchart showing an information processing example executed by the mobile terminal and the information association apparatus in the position specification system in another embodiment;

FIG. 12 is a view schematically showing, in the form of function blocks, an information association apparatus and a mobile terminal constituting a position specification system in still another specific example according to the present invention; and

FIG. 13 is a flowchart showing an information processing example executed by the mobile terminal and the information association apparatus in the position specification system in still another specific example.

### BEST MODE(S) FOR CARRYING OUT THE INVENTION

The present invention will now be described based on a specific example. A position specification system according to the present invention has a configuration that a mobile terminal brought into a vehicle interior detects a signal sound emitted from each speaker provided in the vehicle interior and a position of the mobile terminal in the vehicle interior is specified by using information concerning detection of the signal sound effected by the mobile terminal. Further, it is also a system that is configured to specify a mobile terminal owned by a driver in a vehicle from mobile terminals whose positions in the vehicle interior have been specified. That is, it is a system configured to detect a mobile terminal brought into the vehicle interior and associate information concerning this mobile terminal with information of the vehicle.

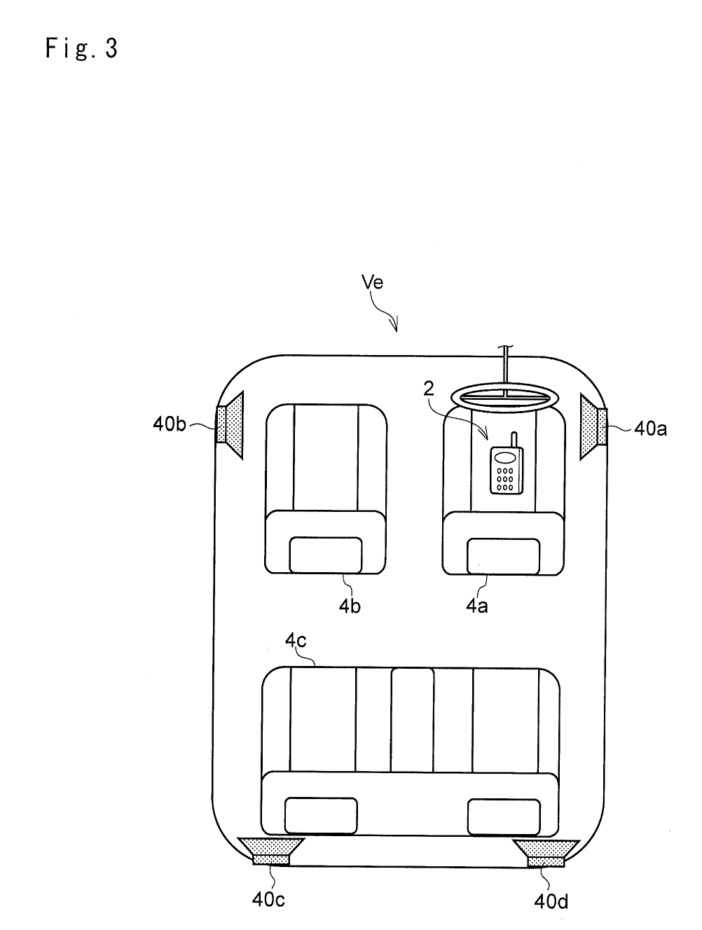

The position specification system in an embodiment according to the present invention will now be described hereinafter with reference to the drawings. As a vehicle to which the position specification system in this embodiment is applied, an automobile having a plurality of speakers provided in a vehicle interior is included. For example, as exemplified in FIG. 3, it is a vehicle Ve including a driver's seat 4a, an assistant driver's seat 4b, and a backseat 4c and also including a speaker 40a on the driver's seat side, a speaker 40b on the assistant driver's side, and speakers 40c and 40d on the backseat side in a vehicle interior. These speakers 40a, 40b, 40c, and 40d are audio speakers that function as output sections of an audio apparatus and output sounds, music, and others to the vehicle interior, and they are provided in the vehicle Ve in advance. Therefore, as the speakers in the present invention, speakers provided in a vehicle in advance can be used. Furthermore, a mobile terminal 2 brought into the vehicle interior is configured to detect signal sounds emitted from the speakers. It is to be noted that providing the plurality of speakers in the vehicle interior can suffice, and constituent members, e.g., vehicle doors on which the speakers installed do not matter. In short, individual control is carried out based on a speaker installed at a position that is relatively close to each seat in the plurality of speakers.

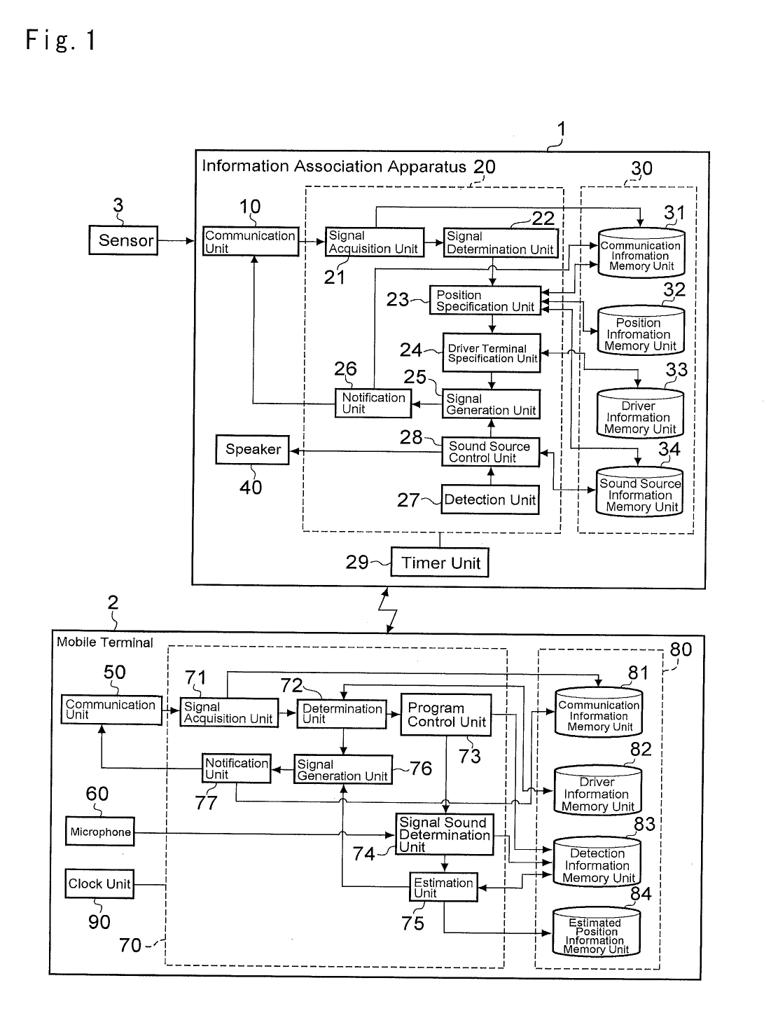

A configuration of the information association apparatus included this position specification system and a configuration of a mobile terminal will now be specifically described with reference to FIG. 1. In this position specification system, the information association apparatus 1 and the mobile terminal 2 brought into a vehicle interior are configured to enable wireless communication with each other. Further, the information association apparatus 1 is configured to receive a signal output from a sensor 3 provided in the vehicle and output a control signal to each speaker 40 provided in the vehicle interior. It is to be noted that FIG. 1 shows one mobile terminal 2 alone as an example, but this position specification system can execute processing of calculating positions of the mobile terminals 2 in the vehicle interior and specifying a driver's mobile terminal 2 even though it is configured to include the plurality of non-illustrated mobile terminals 2.

The information association apparatus 1 has an arithmetic processing device and is configured to control a memory device that stores a computer program executed by the arithmetic processing device and various kinds of data or an external memory device and execute information processing based on the computer program executed by the arithmetic processing device. Therefore, the information association apparatus 1 is constituted of such function blocks as shown in FIG. 1 by way of example and includes a communication unit 10, a control unit 20, a memory unit 30, and each speaker 40.

The memory unit 30 includes a communication information memory unit 31, a position information memory unit 32, driver information memory means 33, and sound source information memory means 34. The communication information memory unit 31 is memory means configured to store communication history information of wireless communication performed with the mobile terminal 2 through the communication unit 10. Specifically, reception history information and transmission history information or communication data included in a communication signal are stored in the communication information memory unit 31. Further, as the communication data included in the communication signal, for example, a type of the communication signal, information indicative of communication contents, identifying information of the mobile terminal 2, and others are included. It is to be noted that information concerning a signal input from the sensor 3 may be stored in the communication information memory unit 31. Furthermore, the communication information memory unit 31 may store estimated position information included in a first notification signal.

The position information memory unit 32 is memory means configured to store position information of the mobile terminal in the vehicle interior. For example, identifying information of the mobile terminal whose position in the vehicle interior has been specified and position information of the same are associated with each other and stored in the position information memory unit 32. Moreover, information concerning relative distances or relative positions of the plurality of speakers 40 and the mobile terminal 2 may be stored in the position information memory unit 32. Additionally, position specification data obtained by mapping ratios of distances between the mobile terminal 2 and the plurality of speakers 40 in the vehicle interior may be stored in the position information memory unit 32. That is, information stored in the position information memory unit 32 may be associated with information stored in the sound source information memory unit 34. Further, a position determination map obtained by partitioning the vehicle interior based on each predetermined determination area, which is a map used for determining a position of the mobile terminal 2 in the vehicle interior, may be stored in the position information memory unit 32. The determination area represents part of a range in the vehicle interior based on arrangement of any seat 4, and it may be, e.g., a range for control that is set as a range according to a position where a driver's seat 4a is provided. That is, information of any seat 4 is associated with each area.

The driver information memory unit 33 is memory means configured to store information concerning a driver and also store information concerning the mobile terminal 2 specified as the driver's mobile terminal in particular. As information stored in this driver information memory unit 33, there are, e.g., identifying information of the mobile terminal 2, date and time information at the time of specification as the driver's mobile terminal, and others. It is to be noted that information used in processing of specification as the driver's mobile terminal may be associated with information stored in this driver information memory unit 33, For example, the reception history information of the first notification signal stored in the communication information memory unit 31 or the position information stored in the position information memory means 32 is associated with driver information stored in the driver information memory unit 33. Furthermore, a driver flag that enables identifying a current driver may be stored in the driver information memory unit 33. For example, a current driver item is provided in a data structure of the driver information memory unit 33, and the driver flag is stored in this item. Moreover, the driver information memory unit 33 may be associated with a non-illustrated vehicle information memory unit. This vehicle information memory unit is memory means configured to store information concerning a vehicle, e.g., a traveling state or a traveling history of the vehicle.

The sound source information memory unit 34 is memory means configured to store sound source information including position estimation signal sound data, information concerning speakers such as arrangement or the number of the speakers 40 installed in the vehicle interior, and information of an order that the plurality of speakers 40 generate position estimation signal sounds.

For example, information indicating that the speakers 40 are arranged at four positions, i.e., a driver's seat side, an assistant driver's seat side, an assistant driver's seat side of a backseat, and a driver's seat side of the backseat is included. Additionally, as the order information, it is possible to set, for example, a pattern number such as an “order pattern 1” indicative of an order “the driver's seat side→the assistant driver's seat side→the assistant driver's seat side of the backseat→the driver's seat side of the backseat” or an “order pattern 2” indicative of an order in the “clockwise direction from the driver's seat side”. It is to be noted that a frequency or the like of the position estimation signal sound is not restricted in particular. That is, whether the position estimation signal sound has a frequency in an audible range or whether it is ultrasonic waves or infrasonic sound does not matter, and a wavelength or an amplitude at the time of propagation in the air does not matter either. Further, in the following description, the position estimation signal sound will be simply written and explained as “signal sound”.

The communication unit 10 is means configured to receive and transmit communication signals when the information association apparatus 1 performs wireless communication with the mobile terminal 2. That is, the communication unit 10 includes a wireless communication antenna as a reception unit and a transmission unit and a control unit that controls the wireless communication. Therefore, the information association apparatus 1 is configured to receive the communication signal transmitted from the mobile terminal 2 and transmit the communication signal generated by a later-described signal generation unit 25 through the communication unit 10.

The control unit 20 includes a signal acquisition unit 21, a signal determination unit 22, a position specification unit 23, a driver terminal specification unit 24, a signal generation unit 25, a notification unit 26, a detection unit 27, a sound source control unit 28, and a timer unit 29. The signal acquisition unit 21 is means configured to acquire a communication signal transmitted by the mobile terminal 2. As the communication signals acquired by the signal acquisition unit 21, there are, e.g., the first notification signal that notifies of a relative position of the mobile terminal 2 and a sound source of the signal sound in the vehicle interior upon accepting the communication signal transmitted by the mobile terminal 2 and a confirmation notification signal that notifies that specification as the driver's mobile terminal has been confirmed. Further, information concerning the communication signal acquired by the signal acquisition unit 21 is stored in the communication information memory unit 31 and output from the signal acquisition unit 21 to the signal determination unit 22.

The signal determination unit 22 is means configured to execute determination processing with respect to communication signals. Specifically, the signal determination unit 22 is configured to determine whether a communication signal transmitted from the mobile terminal 2 has been detected and determine a type of the communication signal. For example, when a type of the received communication signal is determined, it is possible to determine whether the received communication signal is the first notification signal or the confirmation notification signal. It is to be noted that the signal determination unit 22 may be configured to determine whether a plurality of communication signals have been received. Furthermore, information determined by the signal determination unit 22 is output to the position specification unit 23.

The position specification unit 23 is means configured to specify a position of the mobile terminal 2 in the vehicle interior. Specifically, the position specification unit 23 is means configured to specify a relative position relationship of each speaker 40 and the mobile terminal land also specify a position of the mobile terminal 2 in the vehicle interior with the use of estimated position information indicative of a position of the mobile terminal 2 relative to a sound source of a signal sound included in the first notification signal and sound source information concerning production of the signal sound from each speaker 40. This sound source information includes sound source information stored in the sound source information memory unit 34, sound source information that is sound production history information concerning actual production of signal sounds, or the like. For example, this unit is configured to specify the speakers 40 that have actually emitted the signal sounds detected by the mobile terminal 2 and further specify a position of the mobile terminal 2 in the vehicle interior from a ratio of the distances of these speakers 40 and the mobile terminal 2. That is, this position specification unit 23 is processing means that also functions as a calculation unit. Moreover, the position specification unit 23 is configured to function as a determination unit and determine a range in the vehicle interior where a position of the mobile terminal 2 is included. In this case, the position specification unit 23 is configured to refer to the position determination map stored in the position information memory unit 32 and determine a determination area in which a position of the mobile terminal 2 is included. Additionally, when information of the seat 4 is associated with this determination area, specifying a determination area corresponding to the position of the mobile terminal 2 enables specifying the seat 4 associated with the determination area. Further, information concerning the mobile terminal 2 whose position in the vehicle interior has been specified by the position specification unit 23 is stored in the position information memory 32. It is to be noted that the position specification unit 23 may associate information of the mobile terminal 2 and information of the seat with each other and store them. Furthermore, as regards all the first notification signals, when a position of the mobile terminal 2 in the vehicle interior is specified by the position specification unit 23, an instruction signal is input to the driver terminal specification unit 24.

The driver terminal specification unit 24 is means configured to specify the driver's mobile terminal from the mobile terminals 2 carried into the vehicle interior. Specifically, the driver terminal specification unit 24 is configured to specify the mobile terminal 2 placed in a range corresponding to the driver's seat 4a from the mobile terminals 2 whose positions in the vehicle interior have been specified and specify this mobile terminal 2 as the driver's mobile terminal. For example, when presence or absence of the mobile terminal 2 placed in the position determination area associated with information of the driver's seat 4a is determined and such a mobile terminal 2 is present, the mobile terminal 2 that has transmitted the first notification signal is specified as the driver's terminal. Moreover, information concerning the mobile terminal 2 specified as the driver's terminal by the driver terminal specification unit 24 is stored in the driver information memory unit 33 as driver information. It is to be noted that this driver information may include mobile terminal identifying information and may be provided with a driver flag when it is stored in the driver information memory unit 33. Additionally, in case of specifying the driver's terminal based on the confirmation notification signal by way of confirmation, it is confirmed that mobile terminal identifying information included in the specification notification signal coincides with mobile terminal identifying information included in the confirmation notification signal, and the mobile terminal 2 corresponding to the identifying information is specified as the driver's terminal by way of confirmation. In this case, a temporary driver flag may be provided to a record of the driver information stored in the specification processing using the first notification signal, and the temporary driver flag may be definitely registered by the specification processing using the confirmation notification signal. Therefore, at the time of determining the mobile terminal identifying information in the confirmation notification signal, whether this mobile terminal identifying information coincides with the mobile terminal identifying information included in the record having the temporary driver flag may be determined. Further, information based on specification of the driver's mobile terminal performed by the driver information specification unit 24 is input to the signal generation unit 25.

The signal generation unit 25 is means configured to generate communication signals transmitted from the information association apparatus 1. As the communication signals, there are, e.g., a startup instruction signal used for starting up a position estimation program in the mobile terminal 2 and a specification notification signal that notifies the driver's mobile terminal that it has been specified. It is to be noted that the signal generation unit 25 does not have to generate the startup instruction signal every time the startup instruction signal must be transmitted. That is, the startup instruction signal may be stored in a predetermined memory unit in advance, and the startup instruction signal may be read out and input to the notification unit 26 as required. Furthermore, information concerning the notification signal to be transmitted is output to the notification unit 26.

The notification unit 26 is means configured to transmit communication signals from the communication unit 10. Specifically, the startup instruction signal and the specification notification signal are transmitted from the communication unit 10 by the notification unit 26. Moreover, transmission history information concerning communication signals transmitted by the notification unit 26 is stored in the communication information memory unit 31.

The detection unit 27 is means configured to detect signals output from the sensor 3 and also detect a state of the vehicle. For example, the detection unit 27 is configured to detect ignition ON or ignition OFF when a signal from the sensor that has detected the ignition ON or the ignition OFF is input to the information association apparatus 1. Additionally, when the detection unit 27 has detected the ignition ON, a control instruction signal is output to the sound source control unit 28.

The sound source control unit 28 is controlling means configure to enable the speakers 40 to produce the signal sounds. Specifically, the sound source control unit 28 is configured to execute communication control processing for transmitting the startup instruction signal and sound source control processing relative to the speakers 40 based on control information stored in the sound source information memory unit 34 when the control instruction signal is input thereto from the detection unit 27. Further, the plurality of speakers 40 in the vehicle interior are configured so that they can be independently controlled by the sound source control unit 28. For example, the signal sounds are sequentially produced from the respective speakers 40 at equal intervals of a time width. That is, the sound source control unit 28 is controlled in such a manner that any one speaker 40 finishes producing the signal sound and then another speaker 40 starts producing the signal sound. Furthermore, in the position specification system according to this embodiment, the plurality of speakers 40 are configured to produce the same signal sound.

The timer unit 29 is means configured to provide time information to the apparatus mounted in the vehicle. This time information is used for, e.g., a transmission time and a reception time of each communication signal, a detection time when the sensor 3 detects each of various physical quantities, and a time when the detection unit 27 detects a signal input from the sensor 3. Moreover, the time information of the timer unit 29 is also used in case of determining whether a predetermined time has elapsed from the ignition ON. That is, when the predetermined time has elapsed from the ignition ON, the sound source control unit 28 enables each speaker 40 to produce the signal sound. For example, the sound source control unit 28 is configured to determine whether a predetermined time has elapsed from a time at which the control instruction signal was input from the detection unit 27. Alternatively, it may be configured to enable each speaker 40 to start producing the signal sound when a predetermined time has elapsed from a time at which the startup instruction signal was transmitted.

The sensor 3 is a sensor mounted in the vehicle and also an on-vehicle sensor configured to detect a physical quantity that varies in accordance with a state of the vehicle and also detect a change in state of the vehicle. For example, as the sensor 3, an ignition sensor that detects whether a power source of the vehicle can output is included. Furthermore, the sensor 3 may include a pressure sensor that is provided in the driver's seat 4a of the vehicle and detects that a driver has sat on the driver's seat 4a and an opening/closing sensor that detects opening/closing of a vehicle door. For example, a time of the timer unit 29 may be used for information of a time when the pressure sensor detected a change in pressure so that a seating time when the driver sat on the driver's seat 4a can be specified. In this case, a signal output from the pressure sensor includes information of this seating time. Moreover, the opening/closing sensor can likewise output a signal including information of a time when the vehicle door was opened or closed with the use of the time information of the timer unit 29.

The mobile terminal 2 is an apparatus that can be carried by a user like a mobile phone, a smartphone, a tablet type computer, or a PDA (Personal Digital Assistant), and it is also a communication terminal that can wirelessly communicate with other apparatuses. Specifically, it is the mobile terminal 2 including an arithmetic processing device and a memory device, and the arithmetic processing device is configured to control the memory device and execute information processing based on a computer program. Therefore, it is constituted of the mobile terminal 2 and such function blocks as shown in FIG. 1 as an example and includes a communication unit 50, a microphone unit 60, a control unit 70, a memory unit 80, and a clock unit 90.

The memory unit 80 includes a communication information memory unit 81, a driver information memory unit 82, a sound source information memory unit 83, and an estimated position information memory unit 84. The communication information memory unit 81 is memory means that stores communication information as information of a history that the mobile terminal 2 has wirelessly communicated with other apparatuses. For example, as a reception history that the mobile terminal 2 has received communication signals transmitted by the information association apparatus 1, reception history information of the startup instruction signals and reception history information of the specification notification signals are stored in the communication information memory unit 81. Moreover, as a transmission history that the mobile terminal 2 has transmitted communication signals, transmission history information of the first notification signals and transmission history information of the confirmation notification signals corresponding to the specification notification signals are stored in the communication information memory unit 81. It is to be noted that, as a transmission time and a reception time stored in the communication information memory unit 81, time information of the clock unit 90 is used.

The driver information memory unit 82 is memory means that stores information concerning specification as a driver's terminal. For example, as information stored in the driver information memory unit 82, there are identifying information in this mobile terminal 2, information of a history indicative of specification as the driver's mobile terminal, the transmission history information of the confirmation notification signals, the reception history information of the specification notification signals used in processing of transmitting the confirmation notification signals, and transmission history information of position notification signals. It is to be noted that the transmission history information and the reception history information may be a flag indicative of execution of transmission and a flag indicative of execution of reception, and the transmission flag or the reception flag may be associated with the reception history information or the transmission history information stored in the communication information memory unit 81.

The detection information memory unit 83 is memory means that stores detection information concerning detection of signal sounds emitted from the speakers 40. This detection information includes a detection time that is a time at which each of a plurality of signal sounds is detected. Additionally, the detection information memory unit 83 also stores position estimation program configured to detect signal sounds emitted from the speakers 40 and estimate a position of the mobile terminal 2 in the vehicle interior. For example, this position estimation program enables calculating detection intervals that are intervals of detection times based on the detection times and estimating a position of the mobile terminal 2 in the vehicle interior by comparing the detection intervals. That is, information concerning the intervals of the detection times is included in the detection information and stored in the detection information memory unit 83.

The estimated position information memory unit 84 is memory means that stores positional information of the mobile terminal 2 in the vehicle interior. Information stored in this estimated position information memory unit 84 includes detection interval information calculated by the position estimation program and positional information estimated based on the detection intervals.

The communication unit 50 is means that receives and transmits communication signals at the time of performing wireless communication. Specifically, the communication unit 50 includes a wireless communication antenna and means that controls the wireless communication. The microphone 60 is means that detects signal sounds emitted from the speakers 40. It is to be noted that the microphone 60 may be sound detecting means provided in the mobile terminal 2, e.g., a mouthpiece of a mobile phone.

The control unit 70 includes a signal acquisition unit 71, a determination unit 72, a program control unit 73, a sound detection unit 74, an estimation unit 75, a signal generation unit 76, and a notification unit 77. The signal acquisition unit 71 is means that acquires communication signals used in wireless communication through the communication unit 50. For example, as the communication signals acquired by the signal acquisition unit 71, there are the startup instruction signal and the specification notification signal transmitted by the information association apparatus 1. Information concerning the communication signals acquired by the signal acquisition unit 71 is stored in the communication information memory unit 81 and also output from the signal acquisition unit 71 to the determination unit 72.

The determination unit 72 is means that executes determination processing relative to communication signals. Specifically, the determination unit 72 is configured to determine whether a communication signal transmitted from the information association apparatus 1 has been detected and determine a type of the communication signal. For example, it is configured to determine whether the startup instruction signal has been acquired and determine whether the position estimation program is to be started up. Further, the determination unit 72 is configured to determine, based on identifying information of the mobile terminal included in the acquired communication signal, whether the communication signal is a communication signal concerning this mobile terminal. For example, it is configured to determine whether the identifying information of the mobile terminal included in the specification communication signal coincides with the identifying information of this mobile terminal. Furthermore, information concerning a determination result provided by the determination unit 72 is output to the program control unit 73 or the signal generation unit 76.

The program control unit 73 is controlling means that executes the position estimation program. Specifically, it is configured to start up the position estimation program stored in the detection information memory unit 83 based on the startup instruction signal output from the information association apparatus 1 so that signal sounds emitted from the speakers 40 can be detected by the microphone 60.

The signal sound detection unit 74 is means that detects signal sounds emitted from the speakers 40. That is, means that accepts the signal sounds is the signal sound detection unit 74. This signal sound detection unit 74 is configured to operate in a state that the position estimation program has been started up. Furthermore, times at which signal sounds were detected by the signal sound detection unit 74 are stored in the detection information memory unit 83. Moreover, when it is determined that emission of the signal sounds has been completed, e.g., that a predetermined time has elapsed from detection of a last signal sound, an instruction signal is input to the estimation unit 75 from the signal sound detection unit 74.

The estimation unit 75 is means that estimates a relative position of the mobile terminal 2 and a sound source of a signal sound or a position of the mobile terminal in the vehicle interior by using the information of a time at which the signal sound was detected. Specifically, the estimation unit 75 is means that calculates intervals of times at which signal sounds detected at different timings in the same mobile terminal 2 were detected by using detection times of the signal sounds, and estimates relative positions of sound sources of the signal sounds by comparing the plurality of calculated detection intervals with each other. That is, this estimation unit 75 is processing means having a function as a calculation unit. For example, it is configured to calculate a first detection interval that is an interval between a detection time at which a signal sound from a first sound source was detected and a detection time at which a signal sound from a second source was detected. Likewise, it calculates a second detection interval that is an interval between the detection time of the signal sound from the second sound source and a detection time of a signal sound from a third sound source. Further, it is configured to estimate relative positions of the sound sources of these signal sounds and the mobile terminal 2 by comparing the first detection interval and the second detection interval. In detail, a ratio of distances between the respective first, second, and third sound sources and the mobile terminal 2 is calculated, and the ratio of the distances serves as estimated position information obtained by estimating the relative positions of the respective speakers and the mobile terminal 2. It is to be noted that the detection interval explained here is an interval of times at which different signal sounds emitted from different sound sources were detected in the same mobile terminal. That is, it represents a temporal interval in one mobile terminal 2. In other words, the detection interval does not represent an interval of times at which the plurality of mobile terminal 2 detected the same signal sound emitted from the same sound source, respectively. Furthermore, the estimation unit 75 is configured to operate in the state that the position estimation program has been started up. Therefore, when the position estimation program is started up by the program control unit 73, the signal sound detection unit 74 and the estimation unit 75 can execute the processing. Moreover, relative position information is stored in the estimated position information memory unit 84 by the estimation unit 75, and information indicating that the estimation processing has been terminated is input to the signal generation unit 76. It is to be noted that the estimated position information memory unit 84 may store information of the detection times concerning the relative position information or information of the intervals of the detection times.

The signal generation unit 76 is means that generates communication signals transmitted from the mobile terminal 2 based on wireless communication. For example, as the communication signals, there are a first notification signal generated based on execution of the estimation of a relative position of a sound source of a detected signal sound and the mobile terminal 2 and a confirmation notification signal generated when a received specification notification signal corresponds to this mobile terminal 2. The first notification signal includes identifying information of a mobile terminal and a relative position information of a sound source of a signal sound detected by this mobile terminal 2 and this mobile terminal 2. The confirmation notification signal includes information indicative of specification as the driver's terminal and identifying information of the mobile terminal. Moreover, information concerning communication signals generated by the signal generation unit 76 is output to the notification unit 77.

The notification unit 77 is means that transmits communication signals from the communication unit 50. As the communication signals, a first notification signal notifying the information association apparatus 1 of a relative position in the vehicle interior and a confirmation notification signal indicating that specification as the driver's terminal has been confirmed are included. Additionally, transmission history information about communication signals transmitted from the notification unit 77 is stored in the communication information memory unit 81.

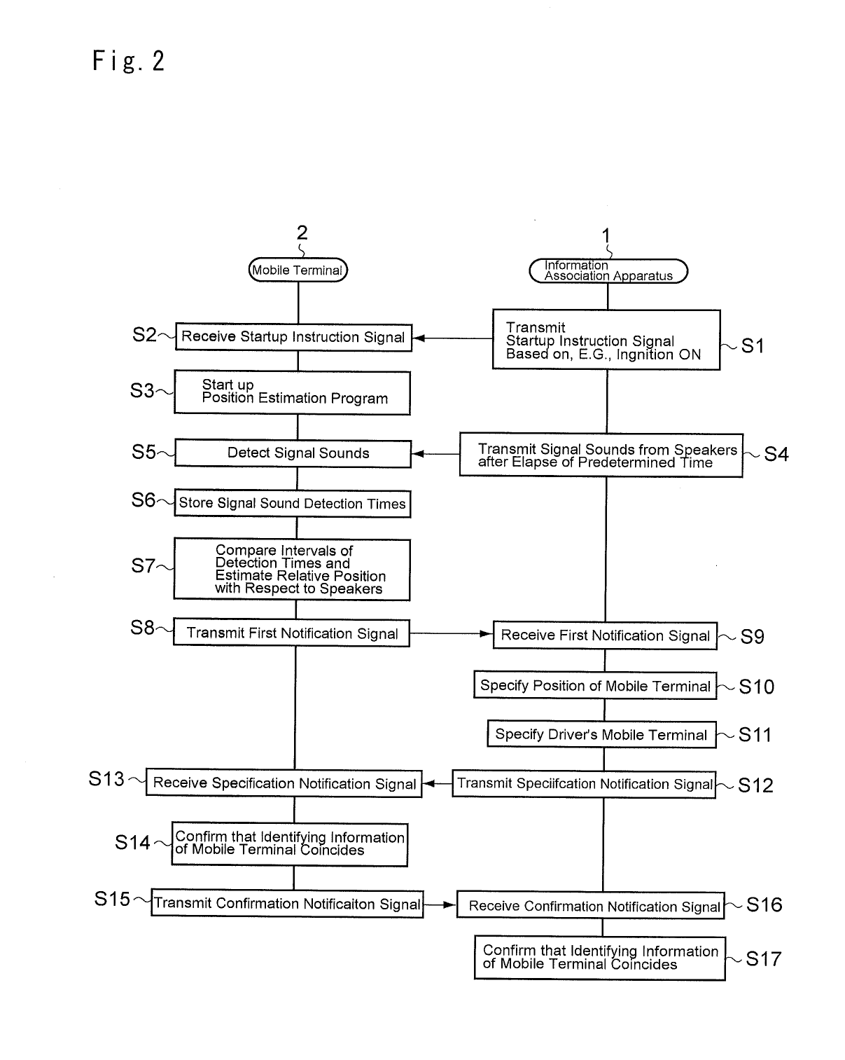

A specification processing sequence relative to the driver's terminal executed in the position specification system will now be described with reference to FIG. 2. First, when the information association apparatus 1 detects that the vehicle has been switched from the ignition OFF state to the ignition ON state, it transmits a startup instruction signal (a step S1). This ignition ON means that a power source of the vehicle can output. That is, as a trigger signal that enables the information association apparatus 1 to execute the processing shown in FIG. 2 as an example, a signal output from the ignition sensor that has detected the ignition ON can be used. Additionally, a time elapsed from a time at which the startup instruction signal was transmitted is measured.

Upon receiving the startup instruction signal transmitted from the information association apparatus 1 (a step S2), the mobile terminal 2 brought into the vehicle interior starts up the position estimation program and enters a signal sound detectable state (a step S3). Specifically, the position estimation program is started up by the program control unit 73, and the signal detection unit 74 and the estimation unit 75 enter a detection or arithmetic operation executable state.

Further, when the information association apparatus 1 determines that a predetermined time has elapsed from the time at which the startup instruction signal was transmitted, the speakers 40 emits signal sounds (a step S4). Specifically, the plurality of speakers 40 sequentially produce the signal sounds at equal intervals of a time width ΔT. For example, as shown in FIG. 3, the signal sounds are produced from the speaker 40a, the speaker 40b, the speaker 40c, and the speaker 40d in the mentioned order. Furthermore, times T at which the signal sounds were produced are times Tₐ, T_{b}, T_{c}, and T_{d} with respect to the speakers 40a, 40b, 40c, and 40d, respectively. In this case, an interval between the sound generation time Tₐ and the sound generation time T_{b}, an interval between the sound generation time T_{b} and the sound generation time T_{c}, and an interval between the sound generation time T_{c} and the sound generation time T_{d} are all equal to each other, and they are intervals ΔT.

The mobile terminal 2 in which the position estimation program is being executed detects the signal sounds emitted from the speakers 40 (a step S5) and stores time information of detection of the signal sounds in the detection information memory unit 83 (a step S6). Assuming that a time at which the signal sound was detected is a time t, a time t₁ at which the signal sound was first detected, a time t₂ at which the second signal sound was detected, a time t₃ at which the third signal sound was detected, and a time t₄ at which the fourth signal sound was detected were stored in the detection information memory unit 83 as detection times. It is to be noted that this mobile terminal 2 according to this embodiment may not determine which speaker 40 produced the detected signal sound. In other words, it is good enough for this mobile terminal 2 to obtain the detection times t of the signal sounds and the number of times of detection of the signal sounds as position estimation data.

Moreover, when the mobile terminal 2 determines that emission of the signal sounds from the speakers 40 is complete by determining that a predetermined time has elapsed from the detection of the signal sounds, it calculates the intervals Δt of the detection times t of the signal sounds and compares the detection intervals At to estimate a position of the mobile terminal 2 in the vehicle interior (a step S7). The detection intervals At are calculated based on the detection times t in accordance with an order of detecting the signal sounds. Additionally, the position of the mobile terminal 2 is estimated by comparing the detection intervals At corresponding to the order of detecting the signal sounds. For example, a detection interval Δtₙ₍ₙ₊₁₎ (=t₍ₙ₊₁−tₙ) is calculated based on an nth detection time tₙ and an “n+1”th detection time t₍ₙ₊₁₎ and, likewise, a detection interval Δt₍ₙ₊₁₎₍ₙ₊₂₎ is calculated. Additionally, positional information of the mobile terminal 2 is estimated by comparing the detection interval Δtₙ₍ₙ₊₁₎ with the of distances between the respective speakers 40 that have emitted the signal sounds and the mobile terminal 2 will be described later in detail. The positional information estimated by the processing at this step S7 is stored in the estimated position information memory unit 84. Further, the mobile terminal 2 transmits a first notification signal including the estimated positional information and the identifying information of the mobile terminal (a step S8).

The information association apparatus 1 receives the first notification signal (a step S9). Furthermore, it specifies a position of the mobile terminal 2 in the vehicle interior by using the estimated position information included in this first notification signal and sound source information stored in the memory unit 30 (a step S10). Moreover, it determines in which area in the vehicle interior the mobile terminal 2 whose position in the vehicle interior has been specified is included. Additionally, if there is the mobile terminal 2 determined to be placed in an area corresponding to the driver's seat 4a, this mobile terminal 2 is specified as the driver's mobile terminal (a step S11). Mobile terminal identifying information of the mobile terminal 2 specified as this driver's terminal is stored in the driver information memory unit 33. Further, upon specifying the driver's mobile terminal, the information association apparatus 1 transmits a specification notification signal indicative of this matter (a step S12). This specification notification signal includes the identifying information of the mobile terminal 2 specified as the driver's terminal by the processing of the step S11.

When the mobile terminal 2 receives the specification notification signal (a step S13), it determines whether the identifying information of the mobile terminal included in the specification notification signal coincides with the identifying information of this mobile terminal 2. When the identifying information of the mobile terminal coincides as a result of this determination, it is determined that this mobile terminal 2 has been specified as the driver's terminal (a step S14). Information confirming that the specification has been effected at this step S14 is stored in the driver information memory unit 82. Furthermore, a confirmation notification signal notifying that the identifying information of the mobile terminal included in the specification notification information coincides is generated, and this confirmation notification signal is transmitted (a step S15). This confirmation notification signal includes at least the identifying information of the mobile terminal 2.

The information association apparatus 1 receives the confirmation notification signal (a step S16). Moreover, when the identifying information of the mobile terminal in the specification notification signal coincides with the identifying information of the mobile terminal included in this confirmation notification signal, the information association apparatus 1 terminates the processing of specifying the driver's terminal in this routine (a step S17). For example, the specification processing may be terminated by updating the driver flag temporarily registered in the driver information memory unit 33 by the processing of the step S11 to be definitely registered.

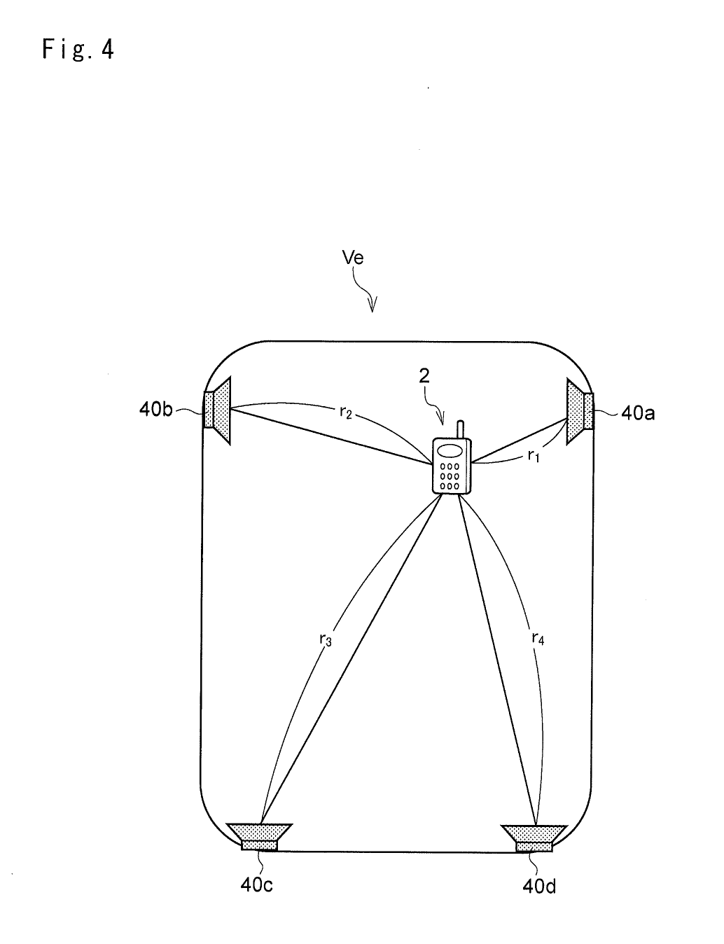

Here, a ratio of distances between the speakers 40 and the mobile terminal 2 calculated by the processing of the step S7 will now be described in detail with reference to FIG. 4. It is to be noted that the signal sounds are assumed to be propagated in the air at a sonic speed M, and distances between the respective speakers 40a, 40b, 40c, and 40d and the mobile terminal 2 are assumed to be r₁, r₂, r₃, and r₄. This calculation processing is configured to calculate detection intervals in accordance with a detection order, and a detection interval Δt₁₂ is calculated based on the first detection time t₁ and the second detection time t₂. In detail, the detection interval “Δt₁₂=t₂−t₁=(T_{b}+r₂/M)−(Tₐ+r₁/M)=(T_{b}−Tₐ)+(r₂−r₁)/M” is calculated. Likewise, an interval between the second and third detection times is calculated as “Δt₂₃=(T_{c}−T_{b})+(r₃−r₂)/M”, and an interval between the third and fourth detection times is calculated as “Δt₃₄=(T_{d}−T_{c})+(r₄−r₃)/M”. Further, when the respective detection intervals Δt are compared in accordance with the detection order, the sound generation times T of the signal sounds are offset by sound generation intervals ΔT, and the ratio of the distances between the speakers 40 and the mobile terminal 2 is calculated. For example, when a deviation Δt′ between interval Δt₁₂ and the interval Δt₂₃ is calculated, since “the sound generation interval ΔT=(T_{b}−Tₐ)=(T_{c}−T_{b})” is achieved, a deviation “Δt′=(r₂−r₁)/M−(r₃−r₂)/M” is calculated, and the ratio of the distances between the mobile terminal 2 and the speakers 40 is calculated. Therefore, even if the mobile terminal 2 does not have information of the sound generation times T of the signal sounds, information of a position in the vehicle interior can be estimated. Thus, the information of a positional of the mobile terminal 2 in the vehicle interior can be estimated based on time information on the mobile terminal side without using time information on the vehicle side. It is to be noted that, as the method for calculating a relative position of the mobile terminal 2 in the present invention, a method for calculating the relative position by comparing the detection intervals Δt can suffice, and the method is not restricted to the above-described calculation method.

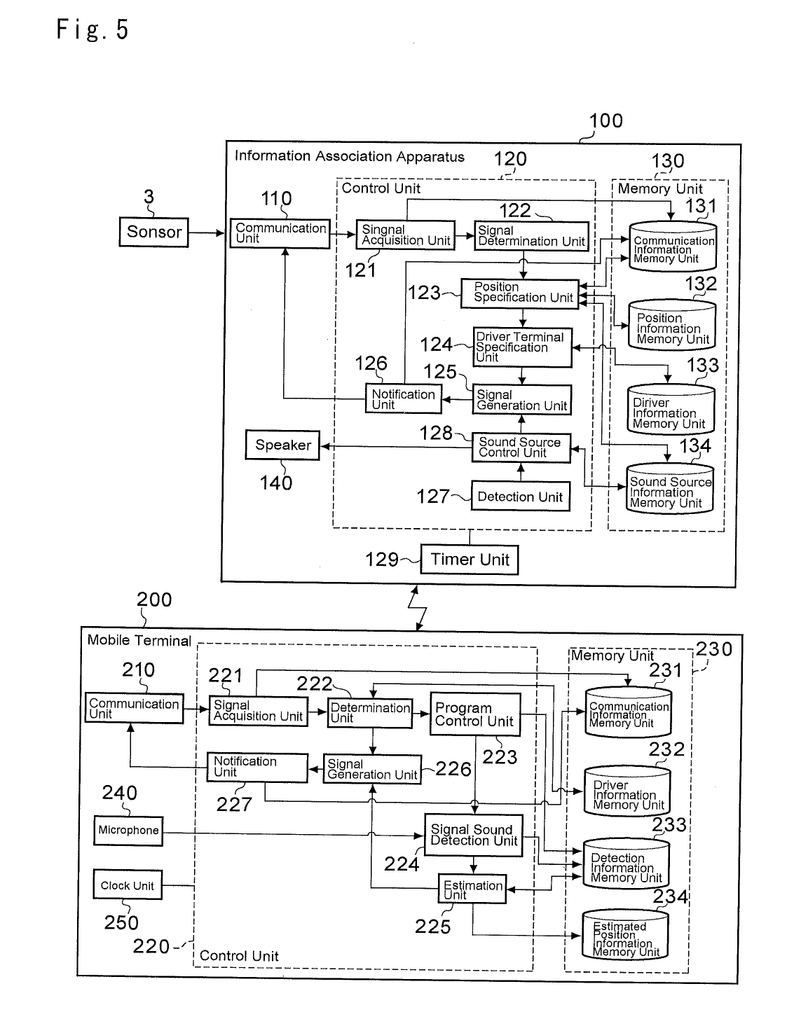

A position specification system according to another embodiment will now be described. In this position specification system, a mobile terminal brought into a vehicle interior is notified of sound source information concerning speakers serving as sound sources of signal sounds and the mobile terminal estimates relative positions of the sound sources of the signal sounds and the mobile terminal in accordance with the sound source information. It is to be noted that a description on a configuration that structures included in this specific example exercise the same functions as those in the above-described specific example will be omitted here. For example, a communication unit 110 in an information specification apparatus 100 exemplified in FIG. 5 has a configuration equivalent to that of the communication unit 10 exemplified in FIG. 1, and the above description of the communication unit 10 will be cited. Likewise, as structures that will be omitted in a description here, the above explanation in which reference numerals shown in FIG. 1 alone are different from those shown in FIG. 5 and the structures have the same name will be cited.

A characteristic configuration provided in a position specification system according to this specific example will be described with reference to FIG. 5. An information association apparatus 100 in this specific example is a modification of the information association apparatus 1, and a mobile terminal 200 is a modification of the mobile terminal 2. Further, speakers 140 have the same configuration as the speakers 40. A sound source information memory unit 134 included in a memory unit 130 provided in the information association apparatus 100 is configured to store sound source information including pattern information selected by sound sources of signal sounds in addition to the configuration of the sound source information memory unit 34. As the pattern information, there is included information of a “selection pattern 1” indicating that all the speakers 140 at four positions are used as the sound sources, a “selection pattern 2” indicating that the speakers 140 at three positions, i.e., a driver's seat side, an assistant driver's seat side, and a driver's seat side of a backseat are used as sound sources, and others. Furthermore, any pattern number of the selection patterns may be set.

A position specification unit 123 is means that specifies a position of the mobile terminal 200 in a vehicle interior based on the selected pattern information in addition to the configuration of the position specification unit 23. For example, it is configured to enable determining in which order signal sounds have been detected and from which speakers 140 the signal sounds have been emitted based on the number of the sound sources and the order included in the pattern information and to specify relative positions of these speakers 140 and the mobile terminal 200. A signal generation unit 125 is configured to generate a sound source notification signal including the pattern information stored in the sound source information memory unit 134 in addition to the configuration of the signal generation unit 25. This sound source notification signal corresponds to the second notification signal in the present invention. A notification unit 126 is means that allows the communication unit 110 to transmit the sound source notification signal in addition to the configuration of the notification unit 26. A sound source control unit 128 is means that controls the speakers 140 that produce the signal sounds in accordance with a vehicle interior conformation of a vehicle Ve, the number of the installed speakers 140, and others in addition to the configuration of the sound source control unit 28. For example, the sound source control unit 128 is configured to select any one of pieces of pattern information stored in the sound source information memory unit 134. Moreover, a signal indicating that this pattern information has been selected is input to the signal generation unit 125 from the sound source control unit 128. Additionally, the sound source control unit 128 is configured to perform sound source control so that a signal sound can be emitted from a predetermined speaker 140 based on this pattern information.

A detection information memory unit 233 of the mobile terminal 200 stores a plurality of position estimation programs in addition to the configuration of the detection information memory unit 83. For example, these programs include programs concerning the plurality of pieces of pattern information. The program control unit 223 is configured to select the position estimation program that should be started up and also start up this program based on the pattern information included in the received sound source notification signal in addition to the configuration of the program control unit 73. A signal sound detection unit 224 is means that detects a signal sounds in accordance with each pattern information in addition to the configuration of the signal sound detection unit 74. For example, in case of pattern information used for performing control so that signal sounds are emitted from the speakers 140 at three positions as sound sources, the signal sound detection unit 224 is configured to recognize that the number of signal sounds to be detected is three in advance and accept the signal sounds. In other words, the signal sound detection unit 224 is configured so that it can determine whether a signal sound corresponding to each pattern information has been detected. For example, it is configured to determine whether the number of the sound sources of the signal sounds included in the pattern information coincides with the number of the time of actually detecting the signal sounds. That is, this signal sound detection unit 224 is processing means having a function as a determination unit. Therefore, when the signal sounds that coincide with the notified sound sources in number have been detected, information indicating that processing of detecting the signal sounds is completed is input to an estimation unit 225 without waiting until a predetermined time elapses. Further, in a case where the number of the detected sounds is less than the number of the notified sound sources, when the predetermined time elapses, information indicative of completion is input to the estimation unit 225. The estimation unit 225 is means that estimates a relative position of each sound source of the signal sound and the mobile terminal in accordance with each pattern information in addition to the configuration of the estimation unit 75. For example, it is configured to enable determining that detection of the signal sounds emitted from any speaker 140 has failed when the number of the detected signal sounds is less than the number of the sound sources included in the pattern information.

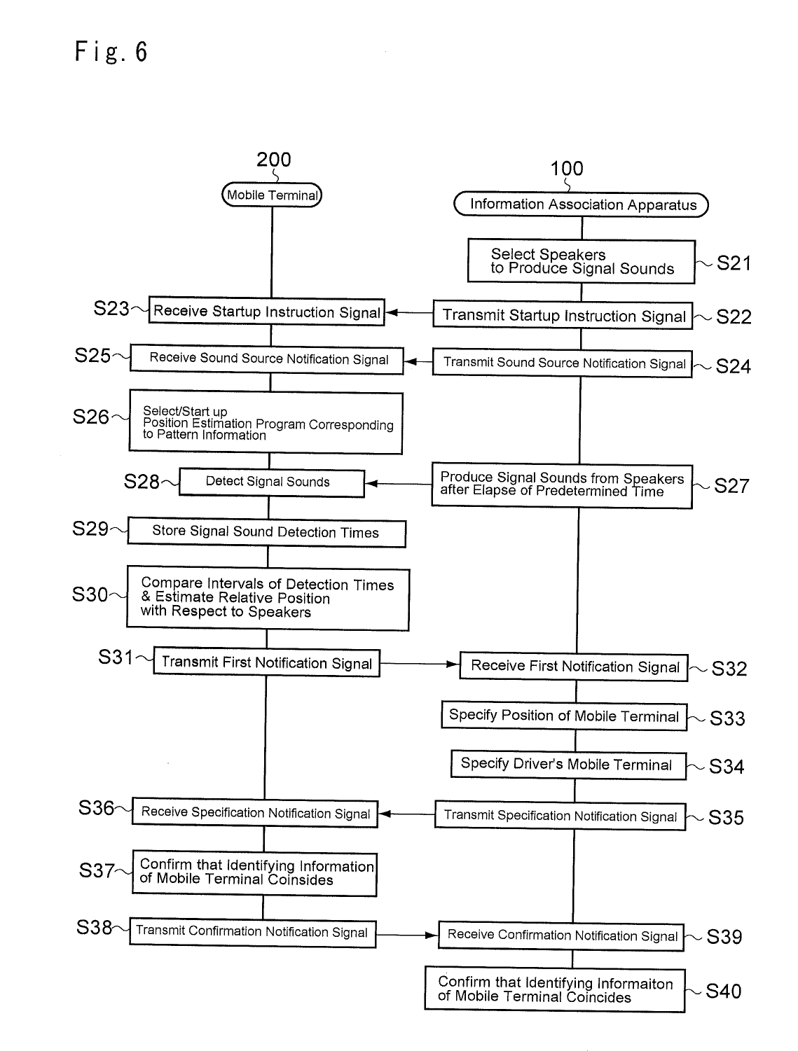

Information processing executed in the position specification system in this specific example will now be described with reference to FIG. 6. In this specific example, the information association apparatus 100 selects a speaker 140 that is allowed to generate a signal sound (a step S21). For example, any one of the pieces of pattern information stored in the sound source information memory unit 34 is selected by the sound source control unit 128, and the speaker 140 corresponding to this pattern information is selected as a sound source. Furthermore, when the information association apparatus 100 detects a trigger signal such as ignition ON, it transmits a startup instruction signal (a step S22), and the mobile terminal 200 receives this startup instruction signal (a step S23). Moreover, when a predetermined time has elapsed from transmission of the startup instruction signal, the information association apparatus 100 transmits a sound source notification signal including the pattern information used for selecting the speaker 140 to generate signal sound (a step S24), and the mobile terminal 200 receives this sound source notification signal (a step S25). It is to be noted that, in the processing exemplified in FIG. 6, the information association apparatus 100 separately transmits the startup instruction signal and the sound source notification signal, but these signals may be transmitted together. For example, a startup instruction signal that enables starting up the position estimation program corresponding to the pattern information may be configured to be transmitted.

Moreover, upon receiving the sound source notification signal, the mobile terminal 200 selects the position estimation program to start up based on the pattern information included in the sound source notification signal, and starts up this program (a step S26). For example, it selects a program corresponding to the pattern information from the plurality of position estimation programs stored in the detection information memory unit 233, and starts up the selected program.

When a predetermined time has elapsed from transmission of the startup instruction signal or the sound source notification signal, the information association apparatus 100 produces a signal sound from each speaker 140 selected as a sound source (a step S27). For example, the processing of the step S27 enables a signal sound to be produced in a predetermined order from each speaker 140 selected based on the pattern information stored in the sound source information memory unit 134. The mobile terminal 200 detects the signal sound (a step S28) and stores a detection time in the detection information memory unit 233 (a step S29). Further, although not shown, in the processing of this step S28, whether the number of the signal sounds that should be detected have been actually detected may be determined based on the number of the sound sources notified by the sound source notification signal in advance. For example, if the sound source notification signal including information indicating that the number of the sound sources is three has been received, processing of a later-described step S30 is immediately executed when the number of the detected signals sources has reached three.

Furthermore, the mobile terminal 200 calculates intervals At between detection times t of the signal sounds and estimates a relative position of a sound source of each signal sound and the mobile terminal 200 by comparing the detection intervals Δt (a step S30). Moreover, in the processing of this step S30, whether the number of the notified sound sources coincides with the number of times of actually detecting the signal sources may be determined. The mobile terminal 200 transmits a first notification signal including the estimated position information (a step S31). It is to be noted that, since the information processing in this specific example is executed in accordance with the position estimation program corresponding to the pattern information, if the number of times of detecting the signal sounds is less than the number of the sound sources notified by the sound source notification signal, information indicating that detecting the signal sound from any speaker 140 has failed may be included in the first notification signal.

Upon receiving this first notification signal (a step S32), the information association apparatus 100 specifies a position of the mobile terminal 200 in the vehicle interior based on the set pattern information (a step S33). For example, the processing of this step S33 enables specifying a position of the mobile terminal 200 in the vehicle interior based on information concerning an installation position of each speaker 140 selected as the sound source and estimated position information included in the first notification signal. Additionally, although not shown, in the processing of this step S32, it is possible to determine in which range in the vehicle interior the specified position information is placed. It is to be noted that processing of a step S34 and subsequent steps exemplified in FIG. 6 are executed like the processing of the step S11 and subsequent steps exemplified in FIG. 2, a description thereof will be omitted.

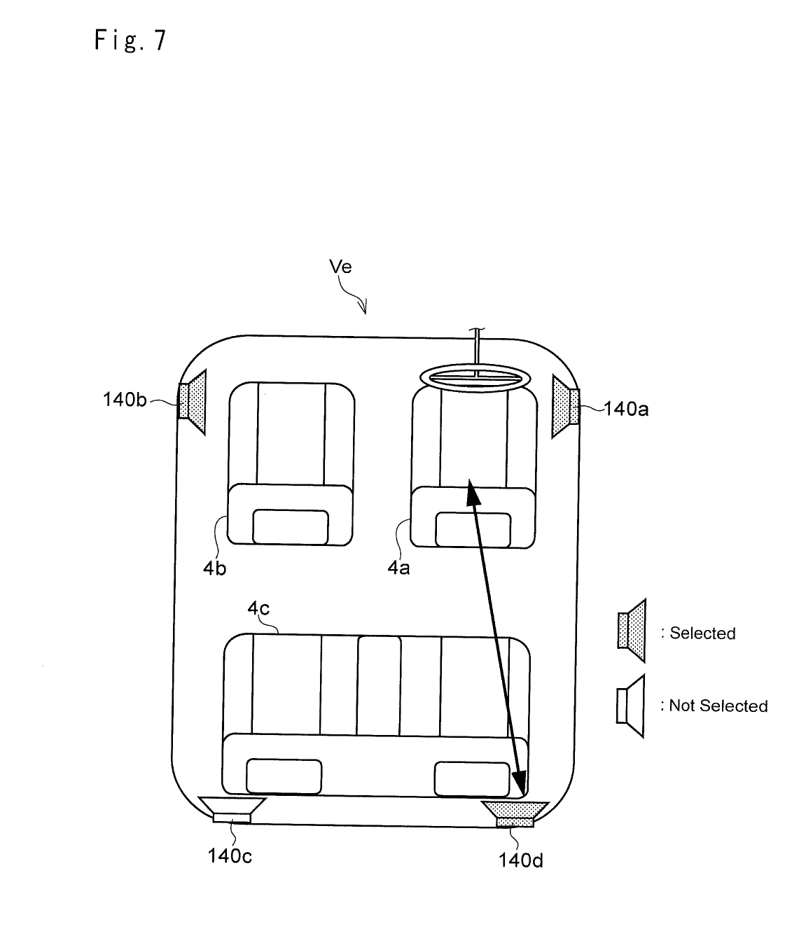

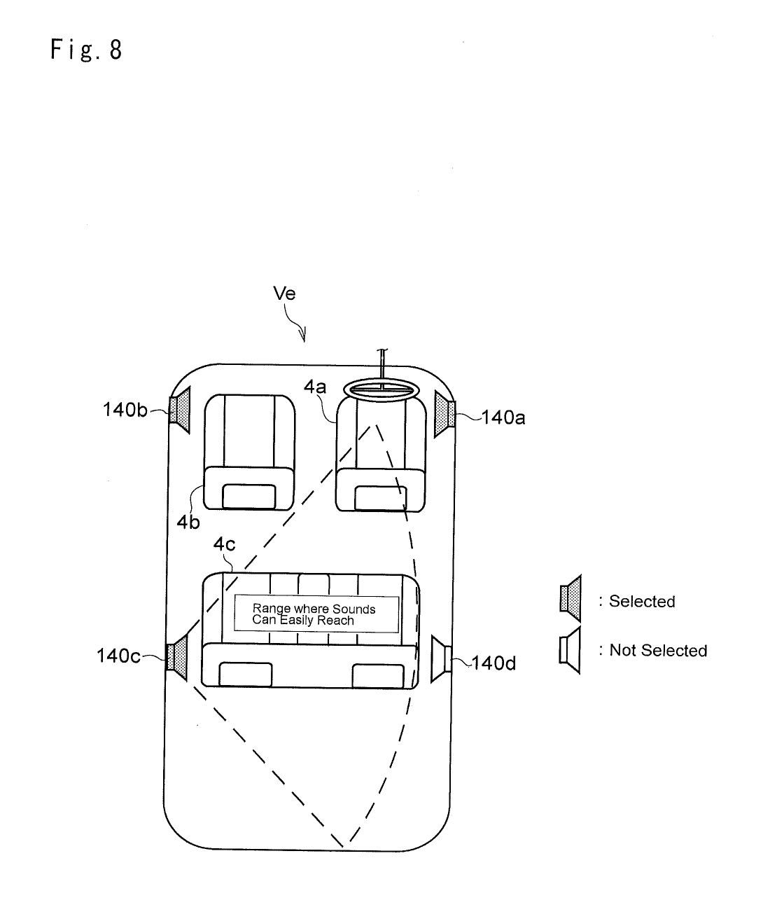

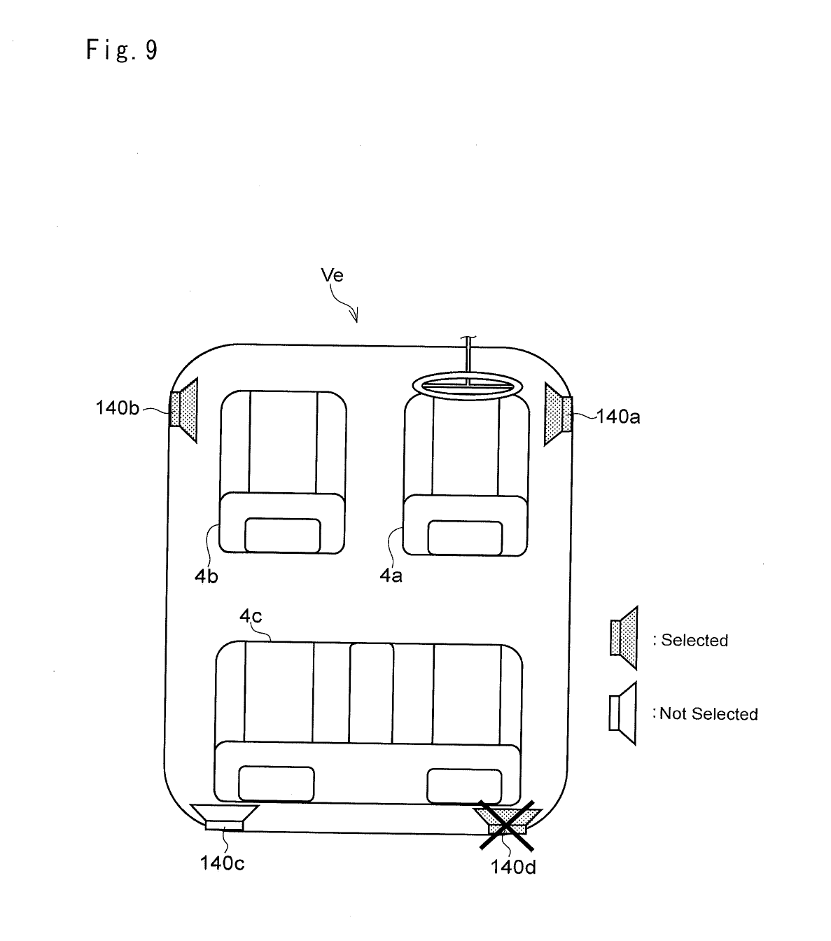

As described above, according to this specific example, it is possible to perform control in such a manner that three speakers 140a, 140b, and 140c can be selected as sound sources of the signal sounds as shown in FIG. 7 as an example and no signal sound is produced from the speaker 140c. In this case, the signal sound detection unit 224 of the mobile terminal 200 can determine whether three signal sounds have been detected. Further, when order information of the speakers 140 that produce the signal sounds is included in the sound source notification signal, it is possible to determine whether the signal sound emitted from each speaker 140 has been detected in the mobile terminal 200. Furthermore, it is good enough to produce the signal sound from the speakers 140 alone which are required to estimate a position of the mobile terminal 200 in the vehicle interior in accordance with a conformation of the vehicle interior or arrangement of the speakers 140. For example, as exemplified in FIG. 8, if a conformation of the vehicle interior is a wagon type, it is possible to perform control so that one of the speakers 140e and 140f provided on the backseat side produces the signal sound. Furthermore, since the mobile terminal 200 has acquired the pattern information in advance, it is possible to determine that the detection in the mobile terminal 200 has actually failed even though the speaker 140 has produced the signal sound. Moreover, it is also possible to determine from which speaker 140 the undetected signal sound has been produced. For example, it is possible to determine that the mobile terminal 200 has failed to detect the signal sound from the speaker 140d that should have been detected according to the pattern information as exemplified in FIG. 9.

Additionally, although the description has been given as to the configuration where a relative position of each sound source of the signal sound is estimated in the mobile terminal in any one of the specific examples, the position specification system in the present invention is not restricted thereto. That is, in the position specification system in the present invention, it is good enough to include the configuration that exercises the function of the estimation unit, which is included in the mobile terminal, in any one of the information association apparatus and the information association apparatus. Therefore, the information association apparatus may be configured to estimate a relative position of the mobile terminal and each sound source of the signal sound.

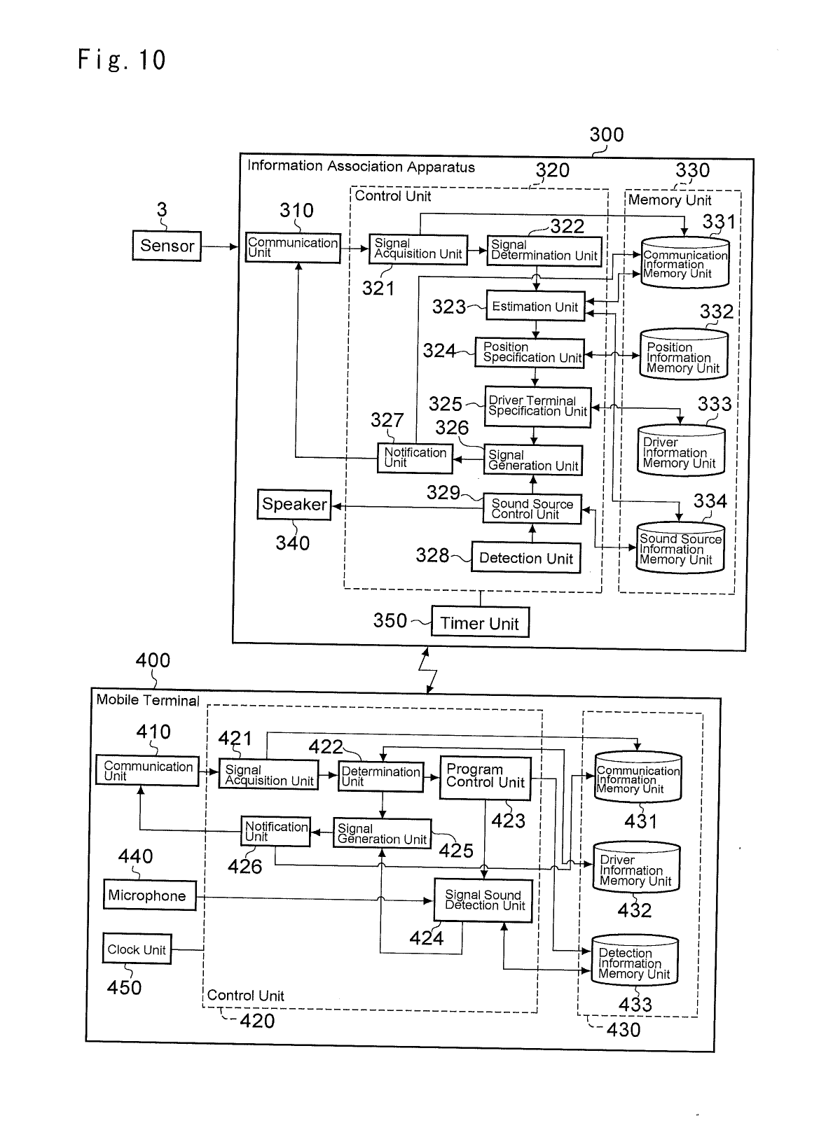

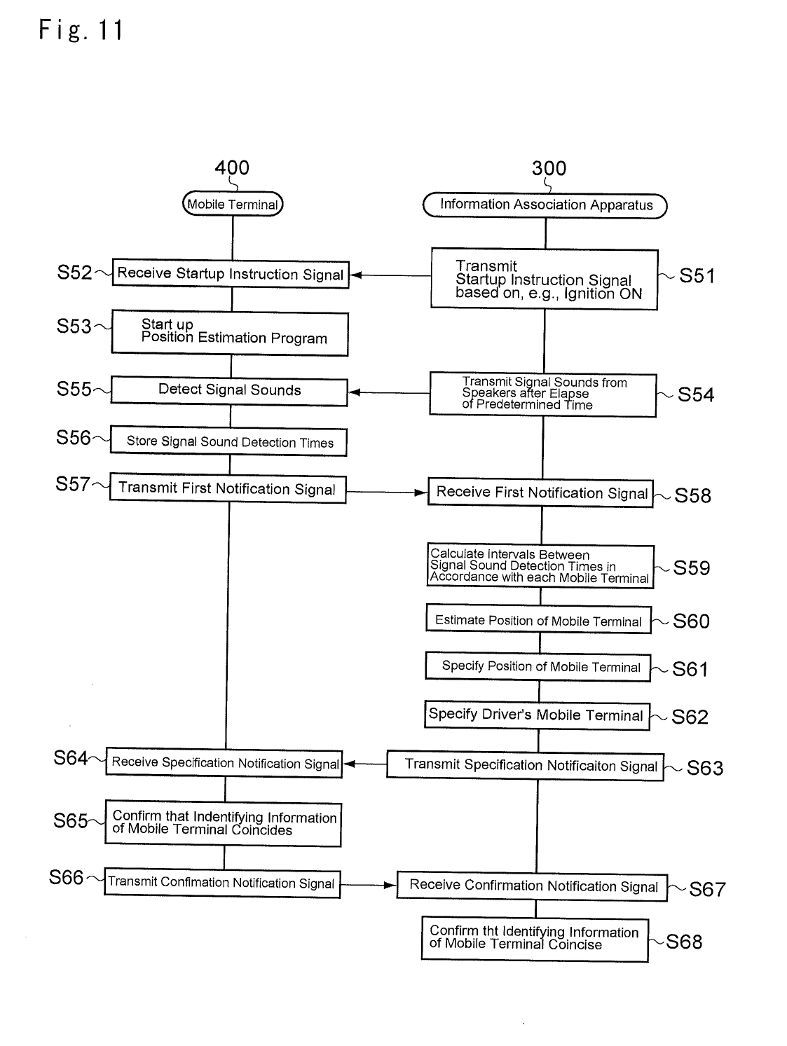

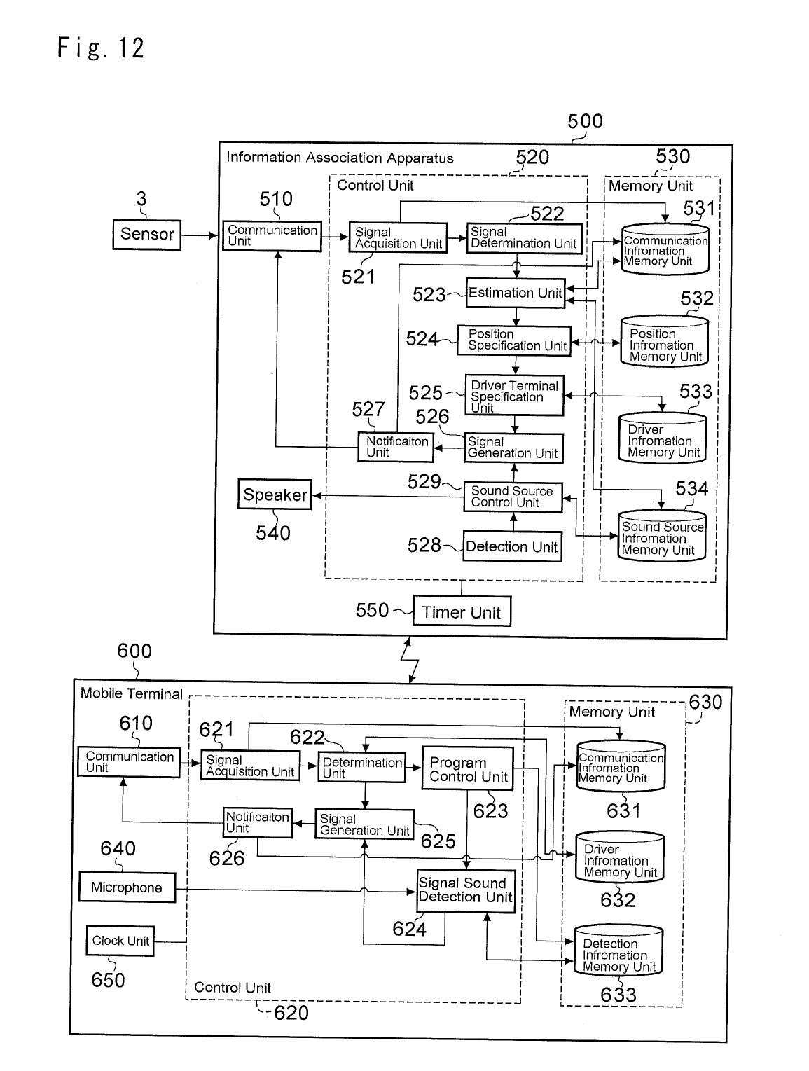

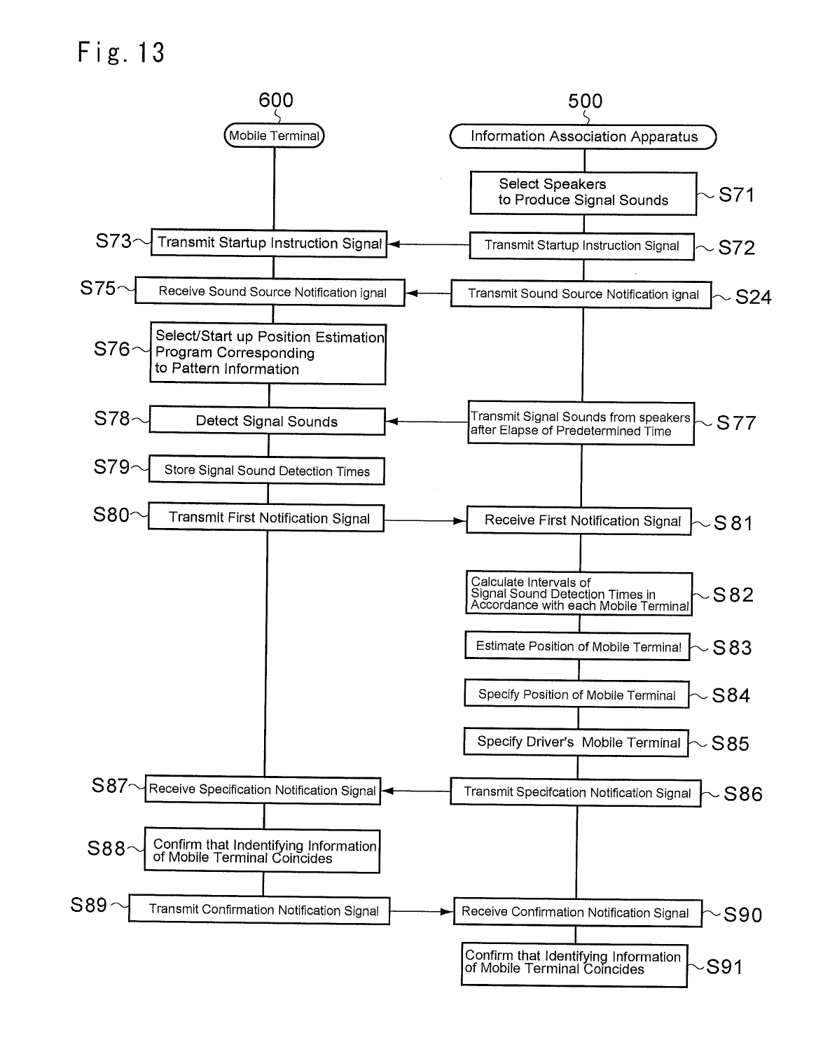

As a specific example thereof, a description will now be given as to a position specification system having a configuration in which an information association apparatus is provided with the function exercised by the estimation unit 75 or the estimation unit 225 provided in the mobile terminal in the above specific examples. As an example, FIG. 10 and FIG. 11 show a specific example where an information association apparatus 300 includes an estimation unit 323 corresponding to the estimation unit 75, and FIG. 12 and FIG. 13 show a specific example where an information association apparatus 500 includes an estimation unit 523 corresponding to the estimation unit 225. That is, the information association apparatus 300 is a modification of the information association apparatus 1 described above with reference to FIG. 1 and FIG. 2, and the information association apparatus 500 is a modification of the information association apparatus 100 described above with reference to FIG. 5 and FIG. 6. Therefore, a description on the same structures as those explained above will be omitted here.

For example, in the position specification system including the information association apparatus 300 and a mobile terminal 400, as exemplified in FIG. 11, the mobile terminal 400 transmits a first notification signal including a detection time t of each signal sound stored in a detection information memory unit 433 at a step S56 and identifying information of this mobile terminal 400 (a step S57). Additionally, it is good enough for detection information included in the first notification signal transmitted at this step S57 to include at least one of information of a time at which each signal sound was detected and information of each interval between detection times. It is to be noted that processing of steps S51 to S56 exemplified in FIG. 11 is the same as the processing of the steps S1 to S6 exemplified in FIG. 2. Further, when the information association apparatus 300 receives the first notification signal (a step S58), it calculates a detection interval At between detection times t in accordance with each identifying information of the mobile terminal based on the detection times t included in the first notification signal (a step S59). It is to be noted that, as described above, when the first notification signal including information of the interval of the detection times is configured to be transmitted at the step S57, the processing of this step S59 may be omitted, and the processing may advance from the step S58 to a step S60. Furthermore, the information association apparatus 300 compares the calculated detection intervals At with each other and estimates a relative position of each speaker 340 serving as a sound source of the signal sound and the mobile terminal 400 (the step S60). Moreover, it specifies a position of the mobile terminal 400 in the vehicle interior based on the estimated position information and sound source information concerning emission from the speakers 340 of the signal sounds stored in a sound source information memory unit 334 (a step S61). It is to be noted that the processing of these steps S60 and S61 may be executed altogether at one step, and the position specification processing at the step S61 may be executed without executing the position estimation processing at the step S60. In a case where the position specification processing at this step S60 is not executed, a relative position of the mobile terminal 400 and each speaker 340 may be calculated by using information of the calculated detection intervals and the sound source information, and a position of the mobile terminal 400 in the vehicle interior may be specified based on the relative position information. Additionally, processing of a step S62 and subsequent steps exemplified in FIG. 11 is the same as the processing of the step S11 and subsequent steps exemplified in FIG. 2.

Further, in a position specification system including the information association apparatus 500 and a mobile terminal 600, as exemplified in FIG. 13, estimation processing for a position of the mobile terminal 600 and specification processing for a position in the vehicle interior are executed at steps S82 and S83. That is, the processing of these steps S82 and S83 functionally corresponds to the processing of the step S30 exemplified in FIG. 6. Therefore, in this information association apparatus 500, the position specification processing of the step S83 can be executed without executing such position estimation processing as exemplified at the step S82, and processing that is integration of the steps S82 and S83 can be also executed. It is to be noted that steps S71 to S79 exemplified in FIG. 13 are the same processing as the steps S21 to S29 exemplified in FIG. 6, and steps S84 to S91 exemplified in FIG. 13 are the same processing as the steps S33 to S40 exemplified in FIG. 6. Therefore, the specific example illustrated in FIG. 10 to FIG. 13 is configured to transmit a first notification signal including at least any one of information of each time at which a signal sound was detected and information of each interval between detection times.

Furthermore, in all the specific examples described above, although the description has been given as to the configuration that each detection interval as an interval between detection times of the signal sounds is calculated in each of the information association apparatuses 300 and 500, the position specification system in the present invention is not restricted thereto. That is, each of the mobile terminals 400 and 600 may be configured to execute processing from the beginning to the detection interval calculation processing, and each of the information association apparatuses 300 and 500 may be configured to specify a position of the mobile terminal in the vehicle interior by comparing the detection intervals. In this case, the above-described first notification signal includes at least the detection interval. Therefore, the functional structures included in each of the estimation units 75 and 225 can be separated in accordance with each function, and including each processing structure that exercises each separated function in either the information association apparatus or the mobile terminal can suffice. In other words, a configuration that the entire position specification system can exercise the functions of each of the estimation units 75 and 225 can suffice.

Moreover, in the above specific example, although the description has been given as to an example where the information association apparatus is included in an electronic control apparatus such as a controller provided in a vehicle, the position specification system according to the present invention is not restricted thereto. For example, the information association apparatus may not be mounted in a vehicle. In this case, vehicle identifying information that enables identifying the vehicle is stored in the information association apparatus, this identifying information of the vehicle is used for wireless communication between a wireless communication apparatus on the vehicle side and the information association apparatus.

Additionally, the vehicle that can adopt the position specification system according to the present invention includes automobiles as well as ships, railways, aircrafts, and others. Further, the information association apparatus may be an apparatus mounted in a vehicle, may be an apparatus provided outside a vehicle, or may be configured to enable wireless communication with a sensor mounted in a vehicle. That is, it may be configured to specify information of a vehicle having a sensor mounted therein by using a communication signal transmitted from this sensor. Furthermore, a pressure sensor may be provided in each of the driver's seat and the assistant driver's seat.

### EXPLANATION OF LETTERS OR NUMERALS

1 . . . information association apparatus, 2 . . . mobile terminal, 3 . . . sensor, 4 . . . seat, 10 . . . communication unit, 20 . . . control unit, 21 . . . signal acquisition unit, 22 . . . signal determination unit, 23 . . . position specification unit, 24 . . . driver terminal specification unit, 25 . . . signal generation unit, 26 . . . notification unit, 27 . . . detection unit, 28 . . . sound source control unit, 30 memory unit, 31 . . . communication information memory unit, 32 . . . position information memory unit, 33 . . . driver information memory unit, 34 . . . sound source information memory unit, 40 . . . speaker, 50 . . . communication unit, 60 . . . microphone, 70 . . . control unit, 71 . . . signal acquisition unit, 72 determination unit, 73 program control unit, 74 . . . signal sound detection unit, 75 . . . estimation unit, 76 . . . signal generation unit, 77 . . . notification unit, 80 . . . memory unit, 81 . . . communication information memory unit, 82 . . . driver information memory unit, 83 . . . sound source information memory unit, 84 . . . estimated position information memory unit, and 90 . . . clock unit.

1-12. (canceled)

13. A position specification system comprising a mobile terminal and an information association apparatus configured to enable wireless communication with each other, the system being configured so that the information association apparatus specifies a position of the mobile terminal in a vehicle interior when the mobile terminal brought into the vehicle interior of a vehicle detects signal sounds produced from speakers provided in the vehicle,
wherein the mobile terminal comprises:
detection information memory unit configured to store detection information concerning a time at which the signal sound produced from each of the plurality of speakers was detected;
first notifying unit configured to transmit a first notification signal including the detection information, and
calculating unit configured to calculate intervals of times at which the plurality of signal sounds were detected respectively, and to calculate relative distances of the sound sources of the signal sounds and the mobile terminal by comparing the calculated intervals with each other,
the information association apparatus comprises:
sound source control unit configured to control so that the signal sound is produced in accordance with each of the plurality of speakers at intervals of a predetermined time width;
second notifying unit configured to transmit a second notification signal including pattern information indicating that two or more speakers, which emit the signal sounds, have been selected from the plurality of speakers; and
position specifying unit configured to specify a position of the mobile terminal in the vehicle interior with the use of relative distances of a plurality of sound sources of the signal sounds and the mobile terminal calculated based on intervals of times at which the signal sounds were detected and the predetermined time width and with the use of information concerning the speakers in a case where the first notification signal has been received;
wherein the detection information includes information concerning the intervals of the times;
wherein the first notifying unit transmits the first notification signal including information of the relative distances;
wherein the calculating unit calculates the relative distances by using the pattern information included in the second notification signal and the intervals of the signal sound detection times when the second notification signal has been received;
wherein the sound source control unit controls the speakers to emit the signal sounds based on the pattern information; and
wherein the position specifying unit is configured to specify a position of the mobile terminal in the vehicle interior with the use of the information of the relative distances included in the first notification signal and the pattern information.

14. The position specification system according to claim 13,
wherein the information concerning the speakers includes at least one of arrangement information of the speakers provided in the vehicle interior and order information of the speakers that have emitted the signal sounds,
the sound source control unit controls the plurality of speakers to emit the signal sounds at equal intervals of a time width,
the calculating unit calculates a ratio of the distances between the plurality of sound sources and the mobile terminal with the use of the intervals of the detection times and the time width of the equal intervals,
the first notification signal including the ratio of the distances is transmitted as the first notification signal, and
the position specifying unit is configured to specify a position of the mobile terminal relative to the plurality of speakers with the use of the ratio of the distances included in the first notification signal.

15. A position specification system comprising a mobile terminal and an information association apparatus configured to enable wireless communication with each other, the system being configured so that the information association apparatus specifies a position of the mobile terminal in a vehicle interior when the mobile terminal brought into the vehicle interior of a vehicle detects signal sounds produced from speakers provided in the vehicle,
wherein the mobile terminal comprises:
detection information memory unit configured to store detection information concerning a time at which the signal sound produced from each of the plurality of speakers was detected;
first notifying unit configured to transmit a first notification signal including the detection information, and
the information association apparatus comprises:
second notifying unit configured to transmit a second notification signal including pattern information indicating that two or more speakers, which emit the signal sounds, has been selected from the plurality of speakers;
sound source control unit configured to control so that the signal sound is produced in accordance with each of the plurality of speakers at intervals of a predetermined time width;
calculating unit configured to compare the intervals between the plurality of times included in the first notification signal with each other and calculate relative distances of the mobile terminal and the speakers by using the intervals when the first notification signal has been received, and
position specifying unit configured to specify a position of the mobile terminal in the vehicle interior with the use of relative distances of a plurality of sound sources of the signal sounds and the mobile terminal calculated based on intervals of times at which the signal sounds were detected and the predetermined time width and with the use of information concerning the speakers in a case where the first notification signal has been received;
wherein the mobile terminal further comprises determining means configured to determine whether the number of the selected speakers included in the pattern information coincides with the number of times of detecting the signal sounds when the second notification signal has been received,
wherein the first notification signal includes information of the intervals between the times at which the signal sounds were detected;
wherein the sound source control unit controls the speakers to emit the signal sounds based on the pattern information;
wherein the calculating unit calculates the relative distances by using the intervals of the times at which the signal sounds were detected and the pattern information; and
wherein the position specifying unit is configured to specify a position of the mobile terminal in the vehicle interior by using the calculated relative distances.

16. The position specification system according to claim 15,
wherein the information concerning the speakers includes at least one of arrangement information of the speakers provided in the vehicle interior and order information of the speakers that have emitted the signal sounds,
the sound source control unit allows the plurality of speakers to emit the signal sounds at equal intervals of a time width,
the calculating unit calculates a ratio of the distances between the plurality of sound sources and the mobile terminal with the use of the intervals of the detection times and the time width of the equal intervals, and
the position specifying unit is configured to specify a position of the mobile terminal in the vehicle interior by using the calculated ratio of the distances.

17. The position specification system according to claim 14,
wherein the information association apparatus further comprises determining unit configured to determine which one of a plurality of determination areas the positional information of the mobile terminal in the vehicle interior corresponds to by using the determination areas provided by dividing the vehicle interior in a predetermined range.

18. The position specification system according to claim 17,
wherein information of seats in the vehicle interior is associated with the determination areas, and
the information association apparatus further comprises driver terminal specifying unit configured to specify the mobile terminal as a driver's mobile terminal when positional information of the mobile terminal corresponds to the determination area associated with information of a driver's seat.

19. The position specification system according to claim 16,
wherein the information association apparatus further comprises determining unit configured to determine which one of a plurality of determination areas the positional information of the mobile terminal in the vehicle interior corresponds to by using the determination areas provided by dividing the vehicle interior in a predetermined range.
